(19) United States
(12) Patent Application Publication
(10) Pub. No.: US 2025/0379899 A1
(43) Pub. Date: Dec. 11, 2025

(54) Multi-Terminal Conference System and Conference Multi-Terminal Collaboration Method

(71) Applicant: Shenzhen Viewplay Co., Ltd., Bao'an Dist (CN)

(72) Inventor: Yi Zhong, Shenzhen (CN)

(73) Assignee: Shenzhen Viewplay Co., Ltd., Bao'an Dist (CN)

(21) Appl. No.: 18/983,251

(22) Filed: Dec. 16, 2024

(30) Foreign Application Priority Data
Jun. 9, 2024 (CN) 2024112531645
Aug. 28, 2024 (CN) 202411189968.3

(51) Int. Cl. H04L 65/403; H04L 12/18; H04L 65/1094

(52) U.S. Cl. CPC H04L 65/403; H04L 12/1831; H04L 65/1094

(57) ABSTRACT

A multi-terminal conference system includes a receiving device connected with a camera and a display terminal, wherein the receiving device is configured to receive a captured content of the camera through a wireless mode so that the captured content can be used as a real-time capture image for uploading to a remote conference. The receiving device further receives a data information of the audio-visual signal corresponding to the remote conference software, decodes the data information to obtain the audio-visual signal corresponding to the data information, and transmits it to the display terminal to display the remote conference, so that the display terminal does not need to install and run any conference software and software driver while ensuring the effect and experience of the conference.

### CROSS REFERENCE OF RELATED APPLICATION

This application is a non-provisional application that claims the benefit of priority under 35 U.S.C. § 119 to a Chinese application, application No. 2024111899683, filed Aug. 28, 2024, and a Chinese application, application No. 20240012531645, filed Sep. 6, 2024, which are incorporated herewith by references in their entireties.

### BACKGROUND OF THE PRESENT INVENTION

### Field of Invention

The present invention relates to the field of communication technology, and more particularly to a multi-terminal conference system and a conference multi-terminal collaboration method.

### Description of Related Arts

With the development of information technology, how to more effectively transmit information between devices becomes a common concern to the public. For example, in a conference scenario, participants often need to project the display information from the personal computer to the large screen in the conference room for presentation, so the stability of information transmission between the personal computer and the large screen of the conference room is particularly important. Due to the shortcomings of traditional wired connection methods, such as difficult wiring and cluttered wiring harnesses, many participants are more inclined to use wireless connections. For example, by connecting the personal computer with the large screen in the same network, the wireless screen projection function is achieved through the network. However, due to the fact that most devices are limited by the different wireless transmission protocols, many computers fail to normally connect to the large screen. In addition, due to the limitation by the influence of network quality, many devices suffer with different degrees of delay jamming during wireless transmission, resulting in a poor experience of wireless transmission. Also, when the personal computer is directly connected to the large screen through the network, there is a risk of virus transmission. Due to the particularity of the conference scenario, for example, when entity A needs to present a program demonstration in the office of entity B, there is a risk of information leakage if it is directly connected to the entity B's Party B's large screen, wherein commercial security cannot be guaranteed.

In view of above, an information transmission system that adopts wireless transmission mode has appeared on the market, which comprises a sending terminal and a receiving terminal wirelessly connected with the sending terminal. The sending terminal utilizes USB interface to connect with the participant's computer, such that the information on the participant's computer is transmitted to the receiving terminal through wireless mode, and then the receiving terminal transmits the received information to the large screen used in the conference through the HDMI interface after processing. Accordingly, the information on the participant's computer is shared to the large screen or other large display terminal of the conference, achieving the screen projection effect. Such independent wireless connection established between the transmitter and receiver substantially avoids the impact of network quality problems and overcomes the limitation of wireless transmission protocols between devices.

However, under the development of the Internet, many offline activities have evolved into network-based online forms, such as in the conference scenario, the Internet-based video remote conference allows the participants to have the meeting or conference thousands of miles apart without gathering in a conference room, which greatly improves the timeliness and the convenience of the meeting or conference. But, in the current use scenario, the vast majority of remote meetings or conferences are combined with offline meetings or conference, such as the company conference room as an offline venue, while the remote participants who reside in the field join the meeting or conference via video conferencing, so that the information transmission system is required to also take into account remote network connectivity and information sharing. As shown in FIG. 1, the Chinese patent application, publication number CN103931175A, discloses an information transmission system for each offline participant 37, which is capable of connecting a network, comprising a first connecting unit 47 connected to a processing device 31 of the offline participant 37. The first connecting unit 47 is wirelessly connected to a second connecting unit 49 which is connected to a display node 36. The display node 36 is connected to a display screen 44, each participant 37 can put the content of the processing device 31 to the display screen 44. The display node 36 can be connected to an Internet 43 through a router 42. Cameras 39, 40, 41 and etc. can be connected to router 42 and the display node 36 through a local area network 51. It is apparent that, in addition to being connected to the Internet 43 for remote video conferencing, it is also necessary to use a corresponding remote conference software which requires the remote users to join only after opening a conference number of a remote meeting/conference room in the remote conference software and logging in the corresponding account. Therefore, according to the technical solution published in the above-mentioned patent application, it also requires the installation of the remote conference software on the display node 36. In other words, the display node 36 needs to put the content transmitted by the processing device 31 to the display screen 44. On the one hand, the conferencing software using must be connected to the remote meeting/conference room.

Generally speaking, the display terminal, such as a display screen like television, projector screen and monitor, equipped in most of the offline meeting/conference room is configured to merely display casting contents so that the processing ability and performance thereof is relatively weak, and thus the processing ability and performance of the display screen do not able to process the projection task, the remote conferencing task and the split-screen real-time display task of the display delivery interface and the remote conference interface at the same time, that results adverse influence and effect to the meeting/conference progress, including situations such as jamming, delay and the like. In addition, when the pictures and audio information of the remote conference room are transmitted to the display screen through the network, the display screen also needs to decode the corresponding information and convert them into audio-visual signals before they can be displayed. But, the general-purpose CPU equipped in the display screen has limited encoding and decoding ability, especially to the audio and video signals, and thus when the corresponding audio-visual information is decoded, the display screen would suffer a decrease in picture clarity, a decrease in sound quality, etc. as well as delaying easily, causing phenomena like jamming during the real-time dynamic projection of the remote meeting/conference, that adversely affects the performance and experience of the remote meeting/conference. At the same time, based on the consideration of information security protection and the trade secret protection, the user has to log in his or her private account on the display screen when the user is having a presentation in an unfamiliar company and required to start a remote meeting/conference. Since most private accounts still have records of previous meetings or conference and even meeting/conference recordings, logging in to their accounts in an unfamiliar environment obviously poses business security risks

### SUMMARY OF THE PRESENT INVENTION

The invention is advantageous in that it provides a multi-terminal conference system and a conference multi-terminal collaboration method, wherein the multi-terminal conference system is configured to allow the offline display terminal thereof to only share the display task without the need to run any remote conference software and to perform any split-screen processing task and encoding/decoding task, so as to effectively guarantee a normal operation of the display terminal.

Another advantageous of the invention is to provide a multi-terminal conference system and a conference multi-terminal collaboration method, which allow the user to log in the remote conference according to his or her own device terminal based on the multi-terminal conference system, so that commercial information security can be guaranteed.

Another advantageous of the present invention is to provide a multi-terminal conference system and a conference multi-terminal collaboration method, wherein the multi-terminal conference system comprises at least a display terminal, a receiving device and a camera, wherein the display terminal and the camera are connected to the receiving device, wherein the receiving device is configured to wirelessly send a captured content of the camera so that the captured content of the camera is uploaded as a real-time videography to the corresponding remote conference software, wherein the receiving device further receives a data information of the audio-visual signal corresponding to the remote conference software, decodes the data information to obtain the audio-visual signal corresponding to the data information, and transmits the decoded data information to the display terminal for casting the remote conference on the display terminal, so that the conference software is avoided from running on the display terminal to guarantee the effect and experience of the conference.

Another advantageous of the present invention is to provide a multi-terminal conference system and a conference multi-terminal collaboration method, wherein the multi-terminal conference system comprises a network terminal and a transmission device, wherein the network terminal is connected to the transmission device while the display terminal is connected to the receiving device and the transmission device is wirelessly connected with the receiving device, so as for transmitting the audio-visual signal of the network terminal to the display terminal for projection, wherein the receiving device is configured to transmit the captured content of the camera to the transmission device, wherein the network terminal is configured to run the remote conference program and be able to input the corresponding remote conference based on the remote conference program, wherein the network terminal inputs the recorded content from the transmission device and is a real-time videography uploaded to the remote conference software with the recorded content, wherein the transmission device directly transmits the audio-visual signal generated based on the built-in audio-visual transmission protocol of the networked terminal from the network terminal, wherein the audio-visual signal is a screen picture signal and/or an audio signal corresponding to the network terminal, which is wirelessly transmitted to the receiving device after being encoded into corresponding data information, wherein the receiving device decodes the data information to obtain the audio-visual signal corresponding to the data information and transmits to the display terminal, wherein the audio-visual signal is displayed by the display terminal for casting the remote conference on the display terminal. Accordingly, the conference software can be avoided from running on the display terminal and the effect and experience of the conference can be guaranteed.

Another advantageous of the present invention is to provide a multi-terminal conference system and a conference multi-terminal collaboration method, wherein the multi-terminal conference system comprises a mobile terminal, wherein the mobile terminal can run a remote conference program and can input the corresponding remote conference based on the remote conference program, wherein the mobile terminal is wirelessly connected to the receiving device based on its own screen projection protocol and receives the recorded content from the receiving device as a real-time videography uploaded to the remote conference software, wherein the mobile terminal transmits the data information corresponding to the audio-visual signal thereof to the receiving device based on its own screen projection protocol, wherein the receiving device decodes the data information to obtain the audio-visual signal corresponding to the data information and transmits the audio-visual signal to the display terminal for displaying the audio-visual signal by the display terminal, so that the remote conference is projected on the display terminal so as to avoid the conference software from running on the display termina and guarantee the effect and experience of the conference.

Another advantageous of the present invention is to provide a multi-terminal conference system and a conference multi-terminal collaboration method, wherein the transmission device comprises an audio-visual signal transmission terminal, wherein the transmission device is connected with the device terminal of the device with built-in corresponding audio-visual transmission protocol through the audio-visual signal transmission terminal, so as to directly input the audio-visual signal generated from the device terminal based on the built-in audio-visual transmission protocol thereof, and/or transmit the corresponding camera signal to the device terminal, corresponding to the state that the transmission device is connected to the network terminal at the audio-visual signal transmission terminal. The transmission device can transmit the camera signal corresponding to a real-time video capturing screen of the camera to the network terminal and directly input the audio-visual signal from the network terminal, without the need to encode by any codec software for driving the processor of the network terminal to be installed on the network terminal, such that the present invention avoids the deceasing of clarity and sound quality of the camera signal and the audio-visual signal due to the encoding and decoding processing of the processor of the network terminal, and prevents any delay generated during the encoding by the processor of the network terminal so as to accomplished a real-time acquisition of information that improves the timeliness and fluency of information transmission to ensure a pleasant using experience for the users.

Another advantageous of the present invention is to provide a multi-terminal conference system and a conference multi-terminal collaboration method, wherein the transmission device comprises a encoding module, which is configured to encode the audio-visual signal inputted by the audio-visual signal transmission terminal, wherein the encoding module generates a data information by means of a special encoder to encode the audio-visual signal, wherein the special encoder is specially designed for encoding to ensure good encoding performance, so that the quality and fluency of the signals are guaranteed, so as to ensure a pleasant using experience for the user, while there is no need to use the processor of the device terminal, connected with the audio-visual signal transmission terminal, to conduct encoding and decoding, and thus the effect and experience of the conference are guaranteed.

Another advantageous of the present invention is to provide a multi-terminal conference system and a conference multi-terminal collaboration method, wherein after the receiving device receives and inputs the captured content from the camera, the receiving device is configured to encode and process the captured content to generate a captured information, thereby reducing the amount of data to be sent by the receiving device wirelessly that facilitates the enhancement of the information transmission efficiency of the multi-terminal conference system.

Another advantageous of the present invention is to provide a multi-terminal conference system and a conference multi-terminal collaboration method, wherein the multi-terminal conference system transmits the captured information of the camera to the transmission device for decoding and processing, thereby avoiding the need to be decoded by the network terminal and install additional codec processing software on the network terminal, that ensures the quality of the camera signal. At the same time, the risk of information leakage caused by the installation of codec processing software is prevented while saving the time for installing the codec processing software, so as to ensure the users' good operating experience.

Another advantageous of the present invention is to provide a multi-terminal conference system and a conference multi-terminal collaboration method, wherein the receiving device comprises a decoding module and at least one audio-visual signal output terminal, wherein the decoding module performs decoding processing on the data information received from the transmission device to obtain the audio-visual signal corresponding to the data information, wherein the receiving device is connected to the display terminal at the audio-visual signal output terminal, so as to transmit the audio-visual signal to the display terminal. Thereby the audio-visual signal of the corresponding device terminal connected to the transmission device can be projected to the display terminal.

Another advantageous of the present invention is to provide a multi-terminal conference system and a conference multi-terminal collaboration method, wherein the multi-terminal conference system further comprises at least one presentation terminal and at least one transmission device, wherein the presentation terminal is connected to the transmission device, which is wirelessly connected to the receiving device. The receiving device transmits the audio and video signal of the network terminal and the audio and video signal of the presentation terminal to the display terminal, so that the display terminal is able to display both the corresponding remote conference and the presentation content at the same time, so as to coordinate the online and offline conference.

Additional advantages and features of the invention will become apparent from the description which follows, and may be realized by means of the instrumentalities and combinations particular point out in the appended claims.

According to the present invention, the foregoing and other objects and advantages are attained by a multi-terminal conference system for processing a remote conference by at least one network terminal, running a remote conference software, equipped with and at least one display terminal and at least one camera configured used for video capturing a scene content where the multi-terminal conference system is located to generate a captured content, wherein the multi-terminal conference system comprises;

at least one receiving device, which comprises a wireless transceiver module, a decoding module, at least one audio-visual signal output terminal, and a camera input terminal, wherein the wireless transceiver module is connected to the decoding module, the audio-visual signal output terminal and the camera input terminal, wherein the camera input terminal is configured for connecting with the camera to input the corresponding captured content from the camera and transmit the corresponding captured content wirelessly through the wireless transceiver module, so as to use the captured content as a real-time capture image for uploading to the remote conference software, wherein the wireless transceiver module further receives a data information of the audio-visual signal corresponding to the remote conference, wherein the decoding module is arranged to decode the data information received by the wireless transceiver module to obtain the audio-visual signal corresponding to the data information, wherein the audio-visual signal output terminal is configured for connecting with the display terminal to transmit the audio-visual signal to the display terminal so as for displaying the remote conference on the display terminal.

In one embodiment, the multi-terminal conference system further comprises a transmission device, wherein while the network terminal is configured to run a remote conference program and input the corresponding remote conference based on the remote conference program, the transmission device comprises an audio-visual signal transmission terminal, an encoding module and a communication module, wherein the audio-visual signal transmission terminal is configured for connecting with the network terminal, and the encoding module is connected to the audio-visual signal transmission terminal and the communication module, wherein the wireless transceiver module is wirelessly connected with the communication module, the communication module of the transmission device is configured to input the data information wirelessly transmitted by the wireless transceiver module. The network terminal inputs the data information from the audio-visual signal transmission terminal while the captured content is used as the real-time capture image uploading to the remote conference software, wherein the transmission device inputs the audio-visual signal of the network terminal from the network terminal at the audio-visual signal transmission terminal. The encoding module encodes and processes the audio and video signal inputted by the audio and video signal transmission terminal and generates the data information, wherein the communication module transmits the data information in a wireless mode and the wireless transceiver module receives the data information.

In one embodiment, the multi-terminal conference system further comprises a mobile terminal, which is configured to run the remote conference software and input the corresponding remote conference based on the remote conference software, wherein the mobile terminal is wirelessly connected to the wireless transceiver module of the receiving device based on its own screen projection protocol to receive the data information transmitted by the wireless transceiver module while the captured content is used as the real-time capture image uploading to the remote conference software, wherein the mobile terminal transmits the data information corresponding to its audio-visual signal to the receiving device based on its own projection protocol.

In one embodiment, the receiving device further comprises a receiving terminal encoding module and the transmission device further comprises a transmitting terminal decoding module, wherein the receiving terminal encoding module is connected to the camera input terminal and the wireless transceiver module and configured to encode and process the captured content inputted from the camera input terminal to generate a captured information. The wireless transceiver module wirelessly transmits the captured information, wherein the transmitting terminal decoding module is connected to the communication module and the audio-visual signal transmission terminal and configured to decode the captured information to obtain the captured content corresponding to the captured information, wherein the audio-visual signal transmission terminal transmits the captured content to the network terminal.

In one embodiment, the receiving device further comprises a receiver encoding module, wherein the receiver encoding module is connected to the camera input terminal and the wireless transceiver module, and configured to encode and process the captured content inputted from the camera input terminal to generate the captured information. The wireless transceiver module wirelessly transmits the captured information. The mobile terminal receives the captured information and decodes the captured information to obtain the captured content corresponding to the captured information.

In one embodiment, the transmission device further comprises an audio recorder module, which is connected to the audio-visual signal transmission terminal and is used to record a sound of the scene where the multi-terminal conference system is located. The audio-visual signal transmission terminal transmits an audio content of the sound corresponding to the sound recorded by the audio recorder module to the network terminal, wherein the network terminal uses the audio content as a real-time audio uploading to the remote conference software.

In one embodiment, the multi-terminal conference system further comprises at least one presentation terminal and at least one other transmission device, wherein an audio-visual transmission terminal of the other transmission device is configured to connect with the presentation terminal to input the audio-visual signal for the presentation terminal from the presentation terminal, wherein the encoding module of the other transmission device is configured to be able to encode and process the audio-visual signal inputted through the audio-visual signal transmission terminal to generate the data information, wherein the communication module of the another transmitting device is wirelessly connected to the wireless transceiver module of the receiving device and is arranged to transmit the data information in a wireless manner, wherein the wireless transceiver module receives the data information, and the decoding module is arranged to decode the data information received by the wireless transceiver module to obtain the audio-visual signal of the presentation terminal corresponding to the data information, wherein the audio-visual signal output terminal transmits the audio-visual signal of the network terminal and the audio-visual signal of the presentation terminal to the display terminal, thereby the display terminal displays both the corresponding remote conference and the presentation content at the same time.

In one embodiment, the transmission device comprises a control module, which is connected to the encoding module and used to control the encoding module to encode the audio-visual signal. The encoding module is in a dormant state by default and is arranged in such a manner that, when the control module is operated once, the encoding module begins to encode the audio-visual signal, and when the control module is operated again, the encoding module switches back to the dormant state and stops encoding. Accordingly, the audio-visual signal of the network terminal and the audio-visual signal of the presentation terminal are selectively transmitted to the display terminal.

In one embodiment, the multi-terminal conference system further comprises at least one mobile terminal, wherein the mobile terminal is wirelessly connected to the wireless transceiver module of the receiving device, wherein the mobile terminal is configured to encode and process corresponding audio-visual signal thereof to generate corresponding data information, and to wirelessly transmit to the wireless transceiver module, wherein the decoding module is arranged to decode the data information received by the wireless transceiver module to obtain the audio-visual signal of the mobile terminal corresponding to the data information, wherein the audio-visual signal output terminal is adapted to transmit the audio-visual signal of the mobile terminal to the display terminal, thereby the display terminal displays the presentation content corresponding to the mobile terminal, wherein based on the operation of the control module of the other transmission device, the audio-visual signal of the presentation terminal and/or the audio-visual signal of the mobile terminal can be selectively displayed to the display terminal.

In one embodiment, the multi-terminal conference system further comprises at least one mobile terminal, wherein the mobile terminal is wirelessly connected to the wireless transceiver module of the receiving device, wherein the mobile terminal is configured to encode and process corresponding audio-visual signals thereof to generate corresponding data information, and to wirelessly transmit to the wireless transceiver module, wherein the decoding module is arranged to decode the data information received by the wireless transceiver module to obtain the audio-visual signal of the mobile terminal corresponding to the data information, wherein the audio-visual signal output terminal transmits the audio-visual signal of the network terminal and the audio-visual signal of the mobile terminal to the display terminal, thereby the display terminal displays the corresponding remote conference and presentation content simultaneously.

In one embodiment, the number of the display terminal is two, and the number of the audio-visual signal output terminal of the receiving device is two, wherein the two audio-visual signal output terminals are correspondingly connected with the two display terminals, wherein the receiving device transmits the audio-visual signal of the network terminal to one of the display terminals and transmits the audio-visual signal of the presentation terminal to the other display terminal.

In one embodiment, the number of the display terminal is two and the number of the audio-visual signal output terminal of the receiving device is two, wherein the two audio-visual signal output terminals are correspondingly connected with the two display terminals, wherein the receiving device transmits the audio-visual signal of the network terminal to one of the display terminals and transmits the audio-visual signal of the presentation terminal and/or the audio-visual signal of the mobile terminal to the other display terminal.

In one embodiment, the number of the display terminal is two and the number of the audio-visual signal output terminal of the receiving equipment is two, wherein the two audio-visual signal output terminals are correspondingly connected with the two display terminals, wherein the receiving device transmits the audio-visual signal of the network terminal to one of the display terminals and transmits the audio-visual signal of the mobile terminal to the other display terminal.

In accordance with another aspect of the invention, the present invention provides a conference multi-terminal collaboration method which comprises steps of:
S1: inputting a captured content of a camera via a camera input terminal of a receiving device connected with the camera;
S2: wirelessly transmitting a corresponding data of the captured content by a wireless transceiver module of the receiving device;
S3: receiving the data transmitted by the wireless transceiver module and uploading the captured content as a real-time capture image of a corresponding remote conference;
S4: encoding and processing an audio-visual signal of the remote conference to generate a data information and transmitting the data information wirelessly; and
S5: inputting the data information by the wireless transceiver module of the receiving device, decoding the data information by a decoding module of the receiving device to obtain the audio-visual signal corresponding to the data information, transmitting the audio-visual signal outputted from the decoding module at an audio-visual signal output terminal of the receiving device to a display terminal, and displaying the remote conference on the display terminal.

In one embodiment, before the step S2, a receiver encoding module of the receiving device encodes the captured content and generates a captured information, wherein in the step S2, the wireless transceiver module wirelessly transmits the data information.

In one embodiment, the step S3 comprises steps of:
S31: receiving the captured information by a communication module of a transmission device;
S32: decoding the captured information received from the communication module by an encoding module of the transmission device to obtain the captured content corresponding to the captured information;
S33: transmitting the captured content by an audio-visual signal transmission terminal of the transmission device to a network terminal; and
S34: running a remote conference program by the network terminal, inputting the corresponding remote conference based on the remote conference program, and inputting the captured content from the transmission device, and using the captured content as a real-time capture image uploading to the remote conference software.

In one embodiment, the step S4 comprises steps of:
S41: inputting the audio-visual signal of the network terminal by an audio-visual signal transmission terminal of the transmission device from the network terminal;
S42: encoding and processing the audio-visual signal inputted through the audio-visual signal transmission terminal by the encoding module to generate the data information; and
S43: transmitting the data information by the communication module in a wireless manner.

In one embodiment, the step S3 comprises steps of:
S31′: receiving the captured information by a mobile terminal from the receiving device based on the mobile terminal's own projection protocol;
S32′: decoding and processing the captured information by the mobile terminal to obtain the captured content corresponding to the captured information; and
S33′: operating a remote conference program in the mobile terminal, inputting the corresponding remote conference based on the remote conference program, and using the captured content as a real-time capture image uploading to the remote conference software.

In one embodiment, the conference multi-terminal collaboration method further comprises steps of:
S6: inputting an audio-visual signal of a presentation terminal by an audio-visual signal transmission terminal of other transmission device from the presentation terminal, encoding and processing the audio-visual signal inputted through the audio-visual signal transmission terminal by an encoding module of the other transmission device to generate a data information, and transmitting the data information by the communication module of the other transmission device in a wireless manner; and
S7: inputting the data information from the communication module of the other transmission device by the wireless transceiver module of the receiving device, decoding the data information received from the wireless transceiver module by the decoding module to obtain the audio-visual signal of the presentation terminal corresponding to the data information, transmitting the audio-visual signal of the network terminal and the audio-visual signal of the presentation terminal to the display terminal by the audio-visual transmission terminal, and displaying the corresponding remote conference and the presentation content on the display terminal at the same time.

In one embodiment, the step S6 further comprises steps of: when a control module of the transmission device is operated once, beginning to encode the audio-visual signal by the encoding module, and when the control module is operated again, switching back the encoding module to a dormant state and stopping encoding.

In one embodiment, the conference multi-terminal collaboration method further comprises steps of:
S8: encoding and processing the corresponding audio-visual signal by a mobile terminal which is connected with the wireless transceiver module of the receiving device to generate the corresponding data information, and wirelessly transmitting the corresponding data information to the wireless transceiver module; and
S9: decoding the data information received by the wireless transceiver module by the decoding module of the receiving device to obtain the audio-visual signal of the mobile terminal corresponding to the data information, and transmitting the audio-visual signal of the presentation terminal and the audio-visual signal of the mobile terminal to the display terminal, displaying both the corresponding remote conference and the presentation content in the display terminal simultaneously.

In one embodiment, in the step S9, the number of the display terminal is two and the number of the audio-visual signal output terminal of the receiving device is two, wherein the receiving device transmits the audio-visual signal of the network terminal to one of the display terminals and transmits the audio-visual signal of the presentation terminal to the other display terminal.

In one embodiment, in the step S9, the number of the display terminal is two and the number of the audio-visual signal output terminal of the receiving device is two, wherein the receiving device transmits the audio-visual signal of the network terminal 30 to one of the display terminals, and transmits the audio-visual signal of the presentation terminal and/or the audio-visual signal of the mobile terminal to the other display terminal.

In one embodiment, in the step S9, the number of the display terminal is two and the number of the audio-visual signal output terminal of the receiving device is two, wherein the receiving device transmits the audio-visual signal of the presentation terminal to one of the display terminals and transmits the audio-visual signal of the mobile terminal to the other display terminal.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view illustrating a conventional signal transmission system.

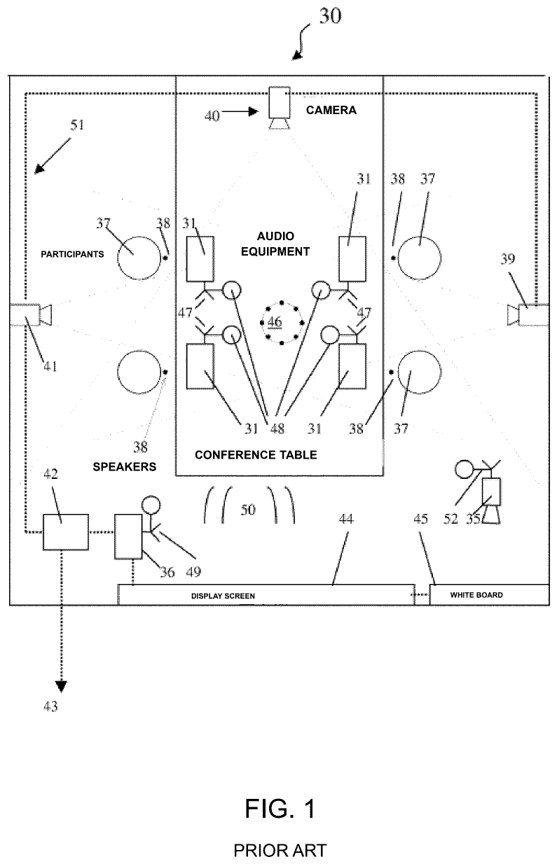

FIG. 2 is a block diagram illustrating a multi-terminal conference system according to a preferred embodiment of the present invention.

FIG. 3 is a block diagram illustrating the multi-terminal conference system according to the above preferred embodiment of the present invention.

FIG. 4 is a block diagram illustrating a transmission device of the multi-terminal conference system according to the above preferred embodiment of the present invention.

FIG. 5 is a block diagram illustrating a receiving device of the multi-terminal conference system according to the above preferred embodiment of the present invention.

FIG. 6 is a block diagram illustrating the multi-terminal conference system according to the above preferred embodiment of the present invention.

FIG. 7 is a block diagram illustrating the multi-terminal conference system according to the above preferred embodiment of the present invention.

FIG. 8 is a block diagram illustrating the multi-terminal conference system according to the above preferred embodiment of the present invention.

FIG. 9 is a schematic view of an implementation scenario of the multi-terminal conference system according to the above preferred embodiment of the present invention.

FIG. 10 is a block diagram illustrating the multi-terminal conference system according to the above preferred embodiment of the present invention.

FIG. 11 is a schematic view of an implementation scenario of the multi-terminal conference system according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art. The broken-line arrows in the drawings illustrate wireless connections.

Throughout this invention, unless explicitly stated otherwise and qualified, when the first feature is described as being “above” or “below” the second feature, this may entail direct physical contact between the two features. Alternatively, it may signify that the first and second features are not in direct contact but are linked through the involvement of additional features. Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In this embodiment's description, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

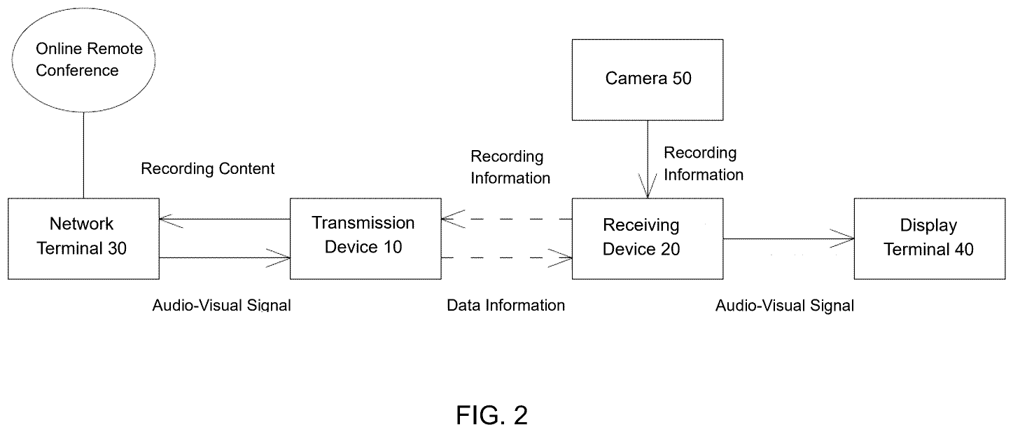

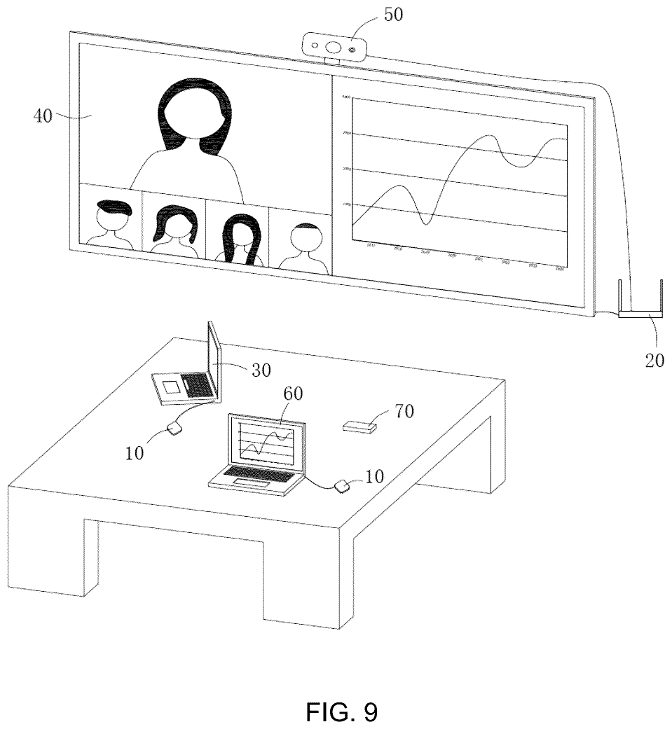

Referring to FIG. 2 to FIG. 5 and FIG. 9 of the drawings, a multi-terminal conference system and a conference multi-terminal collaboration method according to the present invention are illustrated. The multi-terminal conference system, adapted for an online remote conference, comprises at least a receiving device 20, at least one display terminal 40, and at least a camera 50, wherein the display terminal 40 and the camera 50 are connected to the receiving device 20, wherein the receiving device 20 is configured to wirelessly transmit data corresponding to a captured content of the camera 50 such that the captured content is used as a real-time capture image uploading to a corresponding remote conference software, wherein the receiving device 20 is further arranged to receive a data information of an audio-visual signal corresponding to the remote conference software, to decode the data information to obtain the audio-visual signal corresponding to the data information, and to transmit the audio-visual signal to the display terminal 40 for displaying the remote conference on the display terminal 40, without the need to install and run any conference software on the display terminal 40, while ensuring the operative effect and experience of the conference.

It is worth mentioning that the captured content of the camera 50 includes image/video information of the scene where the multi-terminal conference system is located, and may also include audio information of the scene where the multi-terminal conference system is located.

Referring to FIG. 2, the multi-terminal conference system further comprises a transmission device 10 and a network terminal 30 which is connected to the transmission device 10, wherein the transmission device 10 is wirelessly connected with the receiving device 20 in such a manner that the audio-visual signal of the network terminal 30 is able to transmit to the display terminal 40 for displaying. The receiving device 20 is configured to be able to transmit the captured information corresponding to the captured content of the camera 50 to the transmission device 10. The network terminal 30 is configured to be able to run one or more remote conference programs, such as conference software, remote conference websites, and etc., and to input a remote conference correspondingly based on the remote conference program, wherein the network terminal 30 inputs the captured content from the transmission device 10 which is used as a real-time capture image uploading to the remote conference software. That is, the transmission device 10 works as an equivalent camera when the network terminal 30 joins the remote conference.

Further, the transmission device 10 directly inputs the audio-visual signal generated based on the audio-visual transmission protocol built in the network terminal 30 from the network terminal 30. The audio-visual signal is a screen image signal corresponding to the network terminal 30 and/or audio signal for wirelessly transmitting to the receiving device 20 after being encoded into corresponding data information. The receiving device 20 is configured to decode the data information to obtain the audio-visual signal corresponding to the data information, which is transmitted to the display terminal 40, wherein the audio-visual signal is displayed by the display terminal 40, so as for displaying the remote conference on the display terminal 40, that avoids the running of any conference software on the display terminal 40 while ensuring the effect and experience of the conference.

It is appreciated that the multi-terminal conference system inputs the remote conference through the network terminal 30 but not through the large screen of the display terminal 40 in the conference room, such that the user can access the remote conference via the network terminal 30 of his or her own, such as a laptop computer and the like, and project on the large screen in the conference room, especially when conducting a presentation in location of others company without the need to log in the user's conference account on the unfamiliar device, that is conducive to ensuring the security of commercial and private information.

In addition, the user does not need to install any driver software on the network terminal 30, but is able to utilize the camera in the conference room to capture and record the images of the conference room as the real-time capture image to upload to the remote conference software, as well as to costing the content of the remote conference to the display terminal 40 in the conference room.

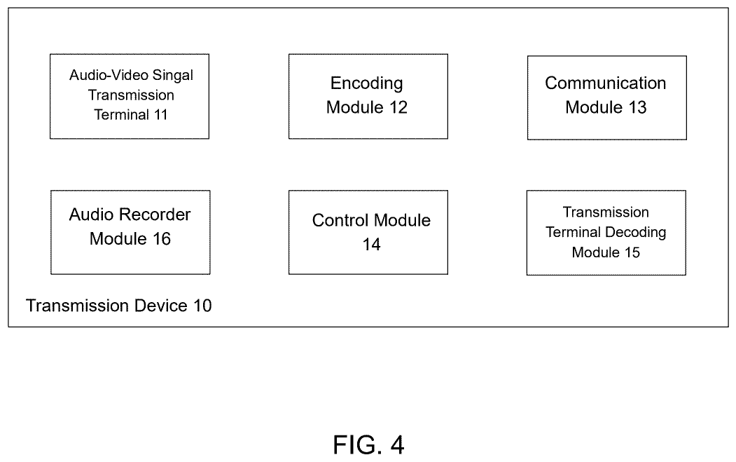

In particular, as shown in FIG. 4, the transmission device 10 comprises an audio-visual signal transmission terminal 11, an encoding module 12 and a communication module 13, wherein the transmission device 10 is connected with a device terminal with the built-in corresponding audio-visual transmission protocol through the audio-visual signal transmission terminal 11, so as to directly input the audio-visual signal generated based on the built-in audio-visual transmission protocol of the device terminal from the device terminal, and/or to transmit the corresponding captured content to the device terminal. Corresponding to the state that the transmission device 10 is connected to the network terminal 30 at the audio-visual signal transmission terminal 11, the transmission device 10 is able to directly transmit the captured content of the real-time capture image of the camera 50 to the network terminal 30, as well as to directly input the audio-visual signal from the network terminal 30 without the need to install any codec software on the network terminal 30 to drive the processor of the network terminal 30 for encoding, that not only significantly avoids adverse situations like decreasing in image resolution and appearance definition and declining in sound quality due to the encoding processing of the capturing signal and the audio-visual signal by the processor of the network terminal 30, but also prevents real-time acquisition of information during the encoding processing by the processor of the network terminal 30, so as to ensure the timeliness and fluency of information transmission and guarantee the user having a good experience feeling.

It is worth mentioning that the transmission device 10 is configured to directly input the audio-visual signal from the network terminal 30, so that the transmission device 10 does not require to install and run any software driver, neither the steps of installing the driver software on the network terminal 30 while connecting the transmission device 10 to the network terminal 30, nor the steps of running any driver while connecting the transmission device 10 to the network terminal 30. In order words, the transmission device of the present invention does not have to store a software drive as well as to set up any storage module.

Further, the encoding module 12 is connected to the audio-visual signal 10 transmission terminal 11 and the communication module 13, wherein the encoding module 12 is configured to encode the audio-visual signal inputted through the audio-visual signal transmission terminal 11, wherein the encoding module 12 encodes the audio-visual signal based on a specific encoder to generate the data information. The specific encoder is specifically designed for encoding so that it has good coding performance to ensure the quality and fluency of the signal. Thereby, the user's good experience feeling is guaranteed while no processor of the device terminal is required to be connected with the audio-visual signal transmission terminal 11 for encoding and decoding processing, that guarantees the effect and experience of the conference.

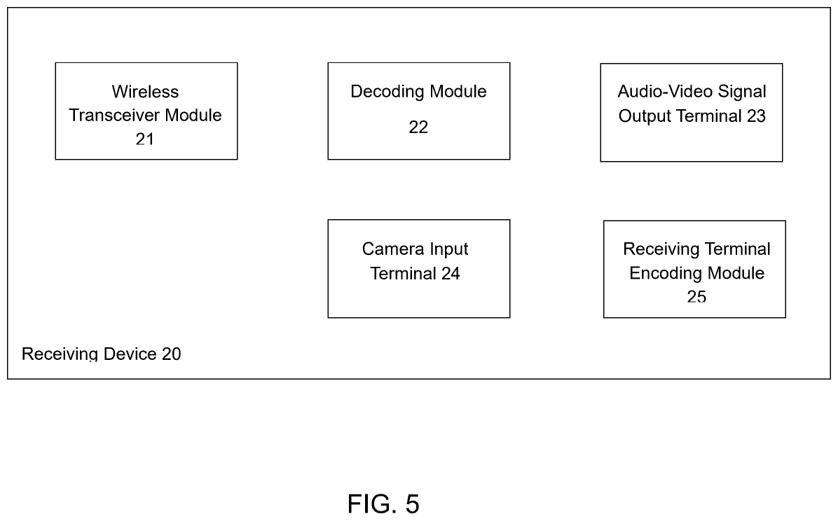

Further, as shown in FIG. 5, the receiving device 20 comprises a wireless transceiver module 21, a decoding module 22, at least one audio-visual signal output terminal 23, and a camera input terminal 24, wherein the wireless transceiver module 21 is connected to the decoding module 22, the audio-visual signal output terminal 23 and the camera input terminal 24. The wireless transceiver module 21 is wirelessly connected with the communication module 13. The camera input terminal 24 is configured for connecting with the camera 50 and inputting the corresponding captured content from the camera 50. The wireless transceiver module 21 is arranged to transmit the data corresponding to the captured content in a wireless manner, wherein the communication module 13 of the transmission device 10 is configured to receive the data transmitted by the wireless transceiver module 21, and the audio-visual signal transmission terminal 11 is configured to transmit the captured content to the network terminal 30, wherein the network terminal 30 is configured to input the captured content from the transmission device 10 and the captured content is used as a real-time capture image to be uploaded to the remote conference software. The transmission device 10 is configured to input the audio-visual signal from the network terminal 30 at the audio-visual signal transmission terminal 11 thereof, and the encoding module 12 is configured to encode and process the audio-visual signal inputted by the audio-visual signal transmission terminal 11 and generates the data information. The communication module 13 is configured to transmit the data information in a wireless manner. The wireless transceiver module 21 is configured to receive the data information and the decoding module 22 is arranged to decode the data information received by the wireless transceiver module 21 to obtain the audio-visual signal corresponding to the data information, wherein the audio-visual signal output terminal 23 is arranged for connecting with the display terminal 40 to transmit the audio-visual signal to the display terminal 40, so that the remote conference is casted on the display terminal 40 and the display terminal 40 is only used as a casting and projection display without processing complex multi-operative tasks, that is conducive to ensuring the normal operation of the conference. The user does not need to install nay program on his or her own terminal device, avoiding the risk of information leakage during installing software on the device terminal to guarantee information security and, at the same time, saving the time of installing software when conducting an online remote conference by the user. The effectiveness and timeliness of information transmission is further enhanced.

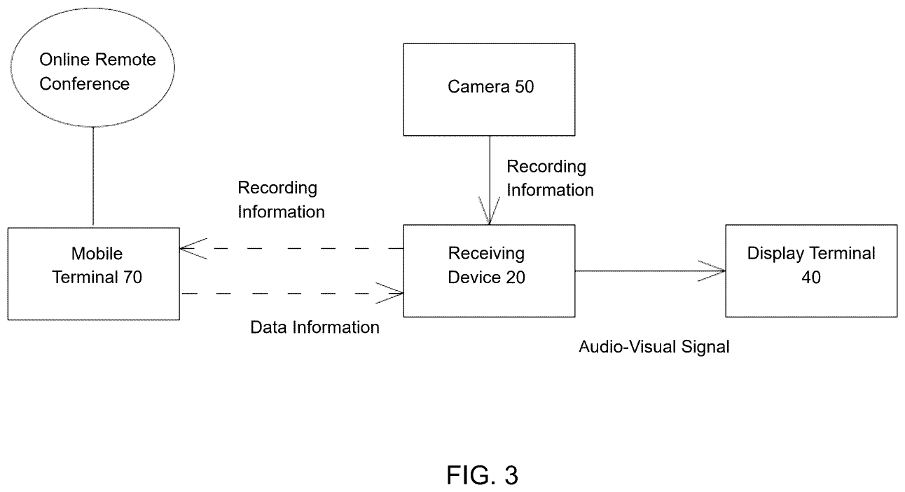

It is worth mentioning that the remote conference can be logged in by a mobile terminal 70, as shown in FIG. 3, wherein the mobile terminal 70 can run the remote conference program and access the corresponding remote conference based on the remote conference program. The mobile terminal 70 is wirelessly connected to the receiving device 20 based on its own projection screen protocol, such that the mobile terminal 70 receives data from the receiving device 20 and takes the captured content as a real-time capture image uploading to the remote conference software. Also, the mobile terminal 70 transmits the data information corresponding to the audio-visual signal thereof to the receiving device 20 based on its own projection protocol, such that the user's mobile terminal 70, such as mobile phone, tablet, and etc., can be used to log in to the remote conference, that substantially improves flexibility and is conducive to ensuring the security of the user's account, wherein the image being uploaded by the mobile terminal 70 to the remote conference can be selected to the image recorded by the camera 50, such that the user is still able to conduct image capturing of the conference room even using the mobile phone.

In particular, the receiving device 20 further comprises a receiving terminal encoding module 25, which is connected to the camera input terminal 24 and the wireless transceiver module 21 and configured to generate a captured information by encoding and processing the captured content inputted from the camera input terminal 24, wherein the wireless transceiver module 21 is configured to wirelessly transmit the captured information, thereby reducing the amount of data to be wirelessly transmitted by the receiving device 20, that is conducive to enhance the information transmission efficiency of the multi-terminal conference system.

It is appreciated that the transmission equipment 10 further comprises a transmission terminal decoding module 15, which is connected to the communication module 13 and the audio-visual signal transmission end 11 and configured to decode the captured information to obtain the captured content corresponding to the captured information, wherein the audio-visual signal transmission terminal 11 directly transmits the captured content to the network terminal 30, thereby avoiding decoding processing based on the network terminal 30 and installing additional codec processing software on the network terminal 30, so as to ensure the quality of the camera signal, avoid the risk of information leakage produced during the installing of the codec processing software and save the time consumed for installing the codec processing software, that provides the user a good operation experience.

In particular, when the receiving device 20 wirelessly transmits the captured information encoded from the captured content, the mobile terminal 70 running the remote conference program receives the captured information from the receiving device 20 and decodes the captured information into the captured content for uploading to the remote conference software as the real-time capture image.

It is appreciated that when the wireless bandwidth between the receiving device 20 and the transmission device 10 and/or the mobile terminal 70 is sufficient, the receiving device 20 can transmit out the captured content after packaging and processing without encoding, while a higher requirement for the speed of wireless transmission is required.

In particular, the transmission device 10 further comprises an audio recorder module 16, which is connected to the audio-visual signal transmission terminal 11 and configured to record the sound of the scene where the multi-terminal conference system is located. The transmission device 10 is configured to transmit an audio content of the sound corresponding to the sound recorded by the radio module 16 to the network terminal 30 via the audio-visual signal transmission terminal 11, wherein the network terminal 30 takes the audio content as a real-time audio to be uploaded to the corresponding remote conference software. Therefore, the transmission device 10 is capable of working as a microphone for the remote conference, that allows the transmission device 10 to be placed according to the position of the transmission device 10, such as placing in the center of the conference table to improve the audio recording equalization of the radio module 16 to all directions of the conference room, that substantially avoids the use of the microphone of the network terminal 30 while it generally placed near a participant of the remote conference and prevents the shortcoming the voice of that participant is much louder than the voices of other participants of the remote conference.

It is worth mentioning that, under the circumstance that the captured content of the camera 50 includes the audio information of the scene where the multi-terminal conference system is located, while the network terminal 30 is logged in to the remote conference, the network terminal 30 has three optional microphone modules, including the microphone built in the network terminal 30, the audio recorder module 16 of the transmission device 10, and the audio information in the captured content recorded by the camera 50, either of them can be selected as the real-time audio being uploaded to the corresponding remote conference software.

In particular, in some embodiments, the camera 50 may further comprises an audio module, wherein the transmission device 10 is configured to transmit the data information of the audio-visual signal corresponding to the network terminal 30 to the receiving device 20, wherein after the receiving device 20 decodes the data information, the image signal thereof can be transmitted to the display terminal 40 for display, and the audio information thereof is transmitted to a broadcasting module of the camera 50 for broadcasting, or alternatively to the speaker of the display terminal 40 for broadcasting. It is understood that an independent broadcasting device terminal can also be arranged, such as an audio equipment, and connected to the receiving device 20, so that the receiving device 20 transmits the audio signal to the audio equipment for broadcasting.

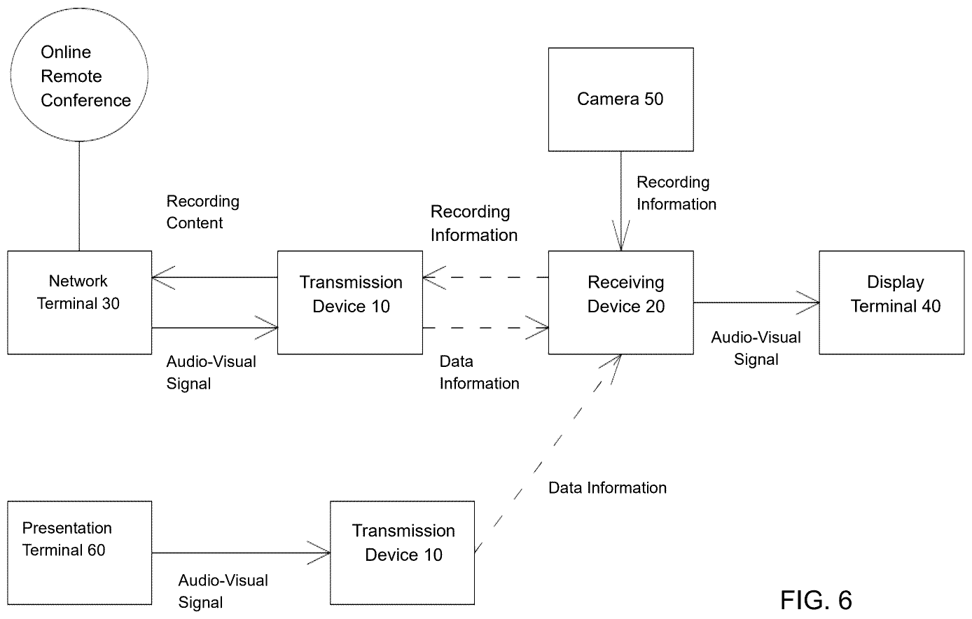

Further, as shown in FIG. 6, the multi-terminal conference system further comprises at least one presentation terminal 60 and at least one other transmission device 10, wherein the audio-visual signal transmission terminal 11 of the other transmission device 10 is configured to be connected with the presentation terminal 60 to input the audio-visual signal of the presentation terminal 60 from the presentation terminal 60, wherein the presentation terminal 60 is configured to display project information discussed in the remote conference, and etc., wherein the encoding module 12 of the other transmission device 10 is configured to encode and process the audio-visual signal inputted via the audio-visual signal transmission terminal 11 to generate a data information, wherein the communication module 13 of the other transmission device 10 is wirelessly connected to the wireless transceiver module 21 of the receiving device 20 and is arranged to transmit the data information in a wireless manner. The wireless transceiver module 21 receives the data information, wherein the decoding module 22 is arranged to decode the data information received by the wireless transceiver module 21 to obtain the audio-visual signal corresponding to the data information of the presentation terminal 60. The audio-visual signal output terminal 23 transmits the audio-visual signal of the network terminal 30 and the audio-visual signal of the presentation terminal 60 to the display terminal 40, so that the display terminal 40 is able to display the corresponding remote conference and presentation content simultaneously while there is no need to run any conference program on the display terminal 40.

In particular, the presentation terminal 60 can also log in to the remote conference to make a presentation content in the remote conference, wherein the receiving device 20 transmits the presentation content of the presentation terminal 60 and the remote conference screen displayed by the network terminal 30 to the display terminal 40. That is, when the remote conference is in progress, the participants of the remote conference can access all the remote conference participants and the presentation content at the same time, without relying on the program support of the remote conference software for the split-screen display. Also, it is not necessary to meet the hardware requirements of the remote conference software to implement the dual-screen output of split-screen display but can be implemented simply by the plug-and-play of the receiving device 20 and the transmission device 10.

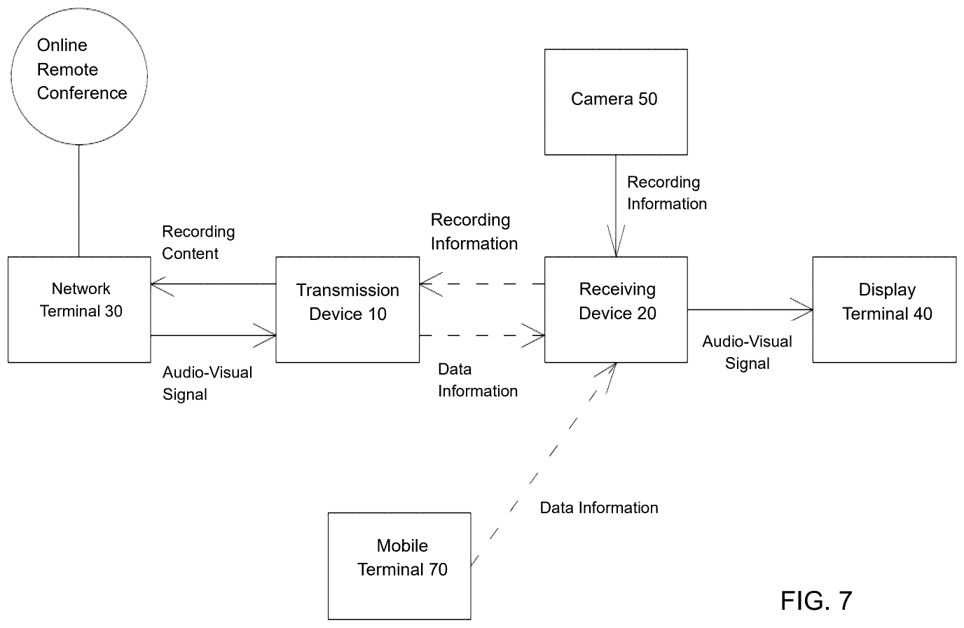

It is worth mentioning that, as shown in FIG. 7, the user is capable of conducting presentation based on his or her own mobile terminal 70 and displaying the presentation on the display terminal 40, wherein the mobile terminal 70 can be the user's mobile phone, tablet, and etc., The mobile terminal 70 is wirelessly connected to the wireless transceiver module 21 of the receiving module 20, wherein the mobile terminal 70 can encode and process the corresponding audio-visual signal thereof and generate corresponding data information which is wirelessly transmitted to the wireless transceiver module 21. The decoding module 22 is arranged to decode the data information received by the wireless transceiver module 21 to obtain the audio-visual signal corresponding to the data information of the mobile terminal 70, wherein the audio-visual signal output terminal 23 transmits the audio-visual signal of the network terminal 30 and the audio-visual signal of the mobile terminal 70 to the display terminal 40, so that the display terminal 40 is able to display the corresponding remote conference and the presentation content simultaneously.

Similarly, the mobile terminal 70 for content presentation can also log in to the remote conference to make content presentation in the remote conference.

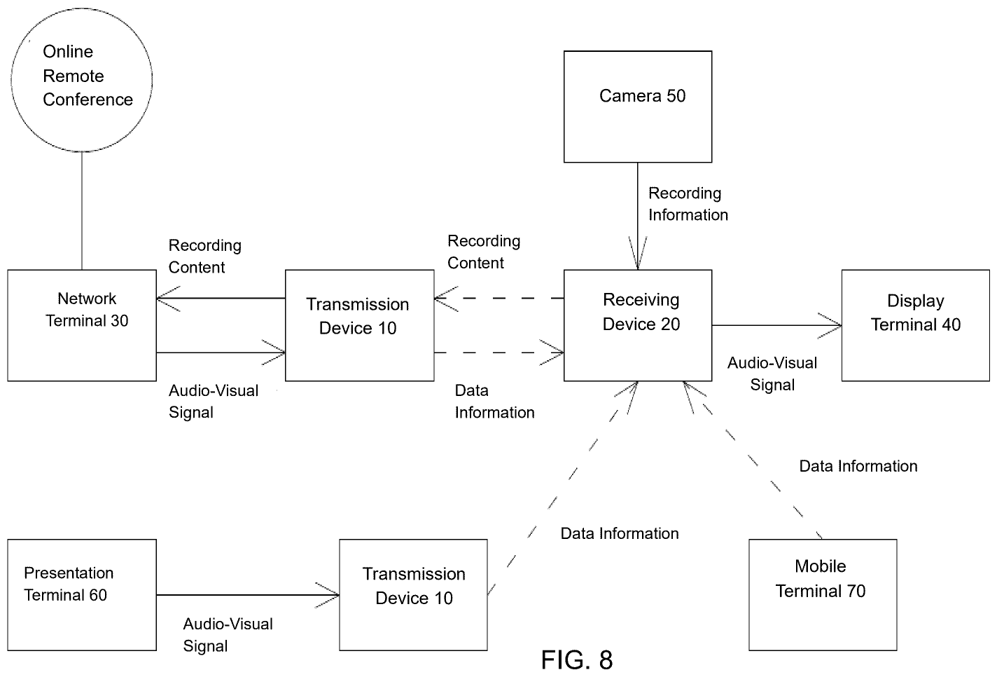

In particular, as shown in FIG. 8, the presentation terminal 60 and the mobile terminal 70 can also conduct presentations at the same time, or alternatively conduct presentations at different times. The present invention does not limit to such arrangement.

It is worth mentioning that the transmission device 10 further comprises a control module 14, which is connected to the encoding module 12 and configured to control the encoding module 12 to encode the audio-visual signal, wherein the coder module 12 is dormant by default and arranged that when the control module 14 is operated once, the encoding module 12 begins to encode the audio-visual signal, and that when the control module 14 is operated again, the encoding module 12 switches back to the dormant state and stops encoding, so that the audio-visual signal of the network terminal 30 and the audio-visual signal of the presentation terminal 60 are selectively displayed on the display terminal 40. Thereby, it prevents the transmitting of the information that does not need to be transmitted to avoid information leakage and guarantee the information security.

For example, when there are multiple presentation terminals incorporated in the multi-terminal conference system for conducting presentations separately, during the control module 14 of the transmission device 10 connected with the presentation terminal 60 that is conducting a presentation is operated, the audio-visual signal of the presentation terminal 60 that is conducting the presentation stops displaying on the display terminal 40, and the control module 14 of the transmission device 10 connected with the presentation terminal 60 for a latter presentation is operated and the audio-visual signal of the presentation terminal 60 of the latter presentation begins to be displayed on the display terminal 40 to process presentation.

It is worth mentioning that, based on the operation of the control module 14, the presentation control between the presentation terminal 60 and the mobile terminal 70 can also be implemented. For example, while the presentation terminal 60 is conducting a presentation, an operation of the control module 14 will stop the processing of the presentation of the presentation terminal 60 and switch to process the presentation of the mobile terminal 70, such that based on the operation of the control module 14, the audio-visual signal of the presentation terminal 60 and/or the audio-visual signal of the mobile terminal 70 can be selectively transmitted to the display terminal 40 for casting, so as to allow the presentations of the presentation terminal 60 and the mobile terminal 70 being separately displayed in different times.

In particular, in some embodiments of the present invention, the control module 14 is connected to the communication module 13 to control the communication module 13 to transmit information. That is, the encoding module 12 encodes the audio-visual signal in real time to generate the data information, and the control module 14 controls whether the communication module 13 transmits the data information, so that the user can control whether the communication module 13 transmits information or not, so as to avoid information leakage and ensure information security. The present invention does not limit such arrangement.

It is worth mentioning that in this preferred embodiment of the present invention, the control module 14 is operated in the mode of pressing or touching. If the control module 14 is embodied to comprise a physical control switch, the user is allowed to operate the control module 14 by pressing the control switch or touching the control switch.

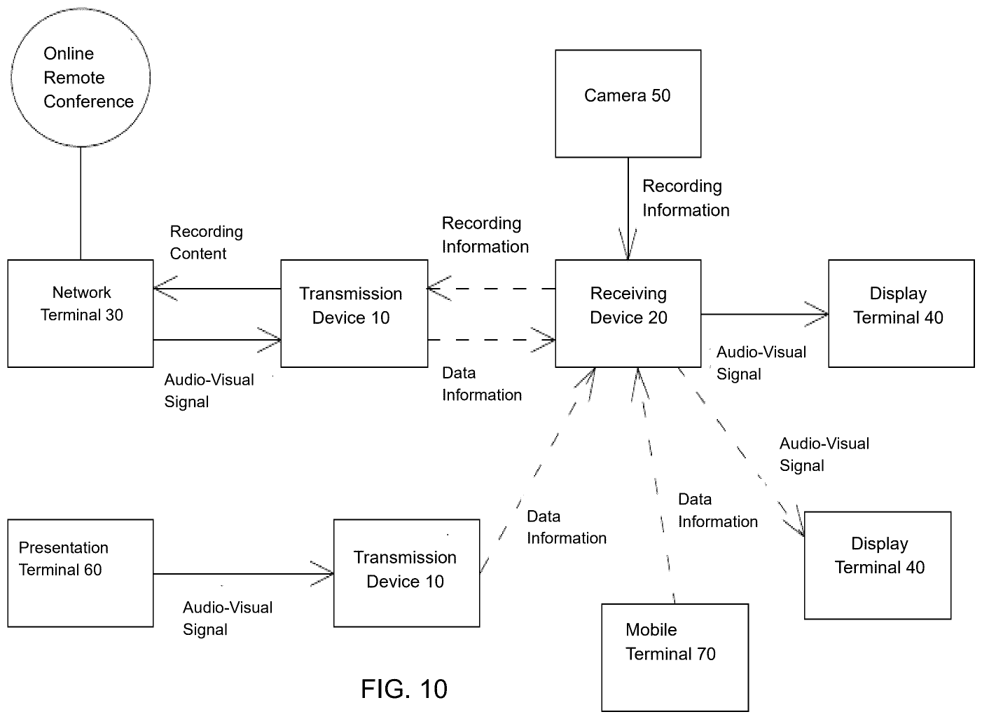

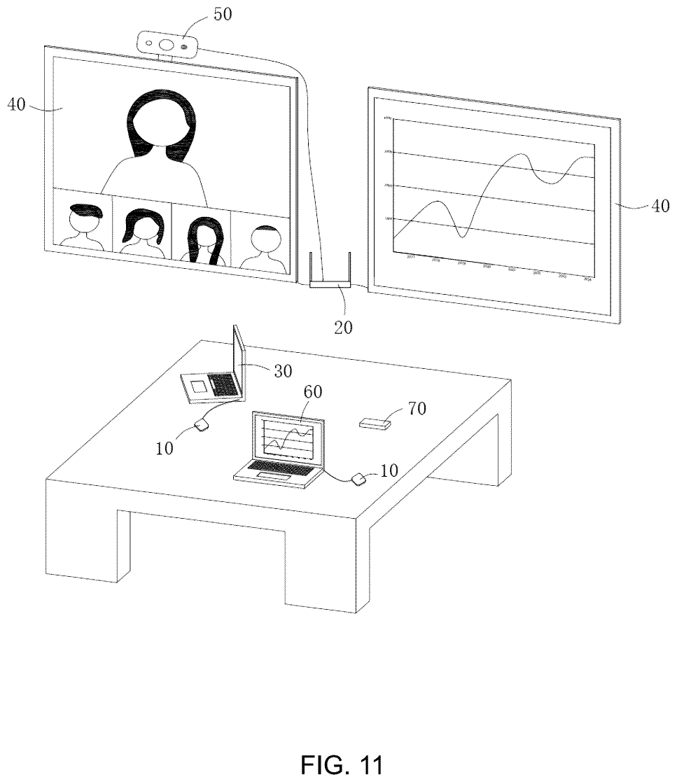

Further, referring to FIG. 10 and FIG. 11, the multi-terminal conference system according to the preferred embodiment of the present invention is embodied to comprise at least two display terminals 40, wherein a first display terminal 40 of the two display terminals is arranged for displaying remote conference content without running remote conference program, and a second display terminal 40 of the two display terminals 40 is arranged for displaying the presentation content of the remote conference. Correspondingly, the receiving device 20 comprises two audio-visual signal output terminals 23 which are correspondingly connected with the two display terminals 40 respectively, wherein a first audio-visual signal output terminal 23 of the two audio-visual signal output terminals 23 is arranged to transmit the audio-visual signal of the network terminal 30 to the first display terminal 40, and a second audio-visual signal output terminal 23 of the two audio-visual signal output terminals 23 is arranged to transmit the audio-visual signals of the presentation terminal 60 and/or the audio-visual signals of the mobile terminals 70 to the second display terminal 40.

It is appreciated that, in the scene where the multi-terminal conference system comprises the at least two display terminals 40, by operating the control module 14 of the transmission device 10, the content of the device terminal connected with the audio-visual signal transmission terminal 11 of the transmission device 10 can be selected to display on the display terminal 40, such as operating the control module 14 once, the content of the device terminal connected with the audio-visual signal transmission terminal 11 of the transmission device 10 is controlled to be displayed in one of the two display terminals 40, and operating the control module 14 continuously operated twice in a row, the content of the device terminal connected with the audio-visual signal transmission terminal 11 of the transmission device is controlled to be displayed in the other one of the two display terminals 40.

In order to further understand the present invention, the present invention also provides a conference multi-terminal collaboration method, comprising steps of

S1: inputting the captured content of the camera 50 via the camera input terminal 24 of the receiving device 20 from the camera 50;
S2: wirelessly transmitting the corresponding data of the captured content by the wireless transceiver module 21 of the receiving device 20;
S3: receiving the data transmitted by the wireless transceiver module 21 and uploading the captured content as a real-time capture image of the corresponding remote conference;
S4: encoding and processing the audio-visual signal of the remote conference to generate the data information and transmitting the data information wirelessly; and
S5: inputting the data information by the wireless transceiver module 21 of the receiving device 20, decoding the data information by the decoding module 22 of the receiving device 20 to obtain the audio-visual signal corresponding to the data information, transmitting the audio-visual signal outputted from the decoding module 22 at the audio-visual signal output terminal 23 of the receiving device 20 to the display terminal 40, and displaying the remote conference on the display terminal 40.

Further, before the step S2, the receiver encoding module 25 of the receiving device 20 encodes the captured content and generates the captured information, wherein in the step S2, the wireless transceiver module 21 wirelessly transmits the data information. Further, the step S3 comprises steps of:

S31: receiving the captured information by the communication module 13 of the transmission device 10;
S32: decoding the captured information received from the communication module 13 by the encoding module 12 of the transmission device 10 to obtain the captured content corresponding to the captured information;
S33: transmitting the captured content by the audio-visual signal transmission terminal 11 of the transmission device 10 to the network terminal 30; and
S34: running a remote conference program by the network terminal 30, inputting the corresponding remote conference based on the remote conference program, and inputting the captured content from the transmission device 10, and using the captured content as a real-time capture image uploading to the remote conference software.

Further, the step S4 comprises steps of:
S41: inputting the audio-visual signal of the network terminal 30 by the audio-visual signal transmission terminal 11 of the transmission device 10 from the network terminal 30;
S42: encoding and processing the audio-visual signal inputted through the audio-visual signal transmission terminal 11 by the encoding module 12 to generate the data information; and
S43: transmitting the data information by the communication module 13 in a wireless manner.

In particular, in one embodiment, the remote conference can be logged in through a mobile terminal 70, wherein, specifically, the step S3 comprises steps of:
S31′: receiving the captured information by the mobile terminal 70 from the receiving device 20 based on the mobile terminal's 70 own projection protocol;
S32′: decoding and processing the captured information by the mobile terminal 70 to obtain the captured content corresponding to the captured information; and
S33′: operating a remote conference program in the mobile terminal 70, inputting the corresponding remote conference based on the remote conference program, and using the captured content as a real-time capture image uploading to the remote conference software.

In addition, the conference multi-terminal collaboration method further comprises steps of:
S6: inputting the audio-visual signal of the presentation terminal 60 by the audio-visual signal transmission terminal 11 of another transmission device 10 from the presentation terminal 60, coding and processing the audio-visual signal inputted through the audio-visual signal transmission terminal 11 by the encoding module 12 of the another transmission device 10 to generate the data information, and transmitting the data information by the communication module 13 of the another transmission device 10 in a wireless manner; and
S7: inputting the data information from the communication module 13 of the another transmission device 10 by the wireless transceiver module 21 of the receiving device 20, decoding the data information received from the wireless transceiver module 21 by the decoding module 22 to obtain the audio-visual signal of the presentation terminal 60 corresponding to the data information, transmitting the audio-visual signal of the network terminal 30 and the audio-visual signal of the presentation terminal 60 to the display terminal 40 by the audio-visual transmission terminal 23, and displaying the corresponding remote conference and the presentation content on the display terminal 40 at the same time.

Further, the step S6 further comprises steps of: when the control module 14 of the transmission device 10 is operated once, beginning to encode the audio-visual signal by the encoding module 12, and when the control module 14 is operated again, switching back the encoding module 12 to a dormant state and stopping encoding.

Further, the conference multi-terminal collaboration method further comprises steps of:

S8: encoding and processing the corresponding audio-visual signal by the mobile terminal 70 which is connected with wireless transceiver module 21 of the receiving device 20 to generate the corresponding data information, and wirelessly transmitting the corresponding data information to the wireless transceiver module 21; and
S9: decoding the data information received by the wireless transceiver module 21 by the decoding module 22 of the receiving device 20 to obtain the audio-visual signal of the mobile terminal 70 corresponding to the data information, and transmitting the audio-visual signal of the presentation terminal 60 and the audio-visual signal of the mobile terminal 70 to the display terminal 40, displaying both the corresponding remote conference and the presentation content in the display terminal simultaneously.

In one embodiment, in the step S9, the number of the display terminal 40 is two and the number of the audio-visual signal output terminal 23 of the receiving device 20 is two, wherein the receiving device 20 transmits the audio-visual signal of the network terminal 30 to one of the display terminals 40, and transmits the audio-visual signal of the presentation terminal 60 and/or the audio-visual signal of the mobile terminal 70 to the other display terminal 40.

In one embodiment, in the step S9, the number of the display terminal 40 is two and the number of the audio-visual signal output terminal 23 of the receiving device 20 is two, wherein the receiving device 20 transmits the audio-visual signal of the presentation terminal 60 to one of the display terminals 40, and transmits the audio-visual signal of the mobile terminal 70 to the other display terminal 40.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. A conference multi-terminal collaboration method, comprising steps of:
(a) inputting a captured content of a camera via a camera input terminal of a receiving device connected with the camera;
(b) wirelessly transmitting a corresponding data of the captured content by a wireless transceiver module of the receiving device;
(c) receiving the corresponding data transmitted by the wireless transceiver module and uploading the captured content as a real-time capture image of a remote conference;
(d) processing an audio-visual signal of the remote conference to generate a data information and transmitting the data information wirelessly;
(e) inputting the data information by the wireless transceiver module of the receiving device;
(f) obtaining the audio-visual signal corresponding to the data information;
(g) transmitting the audio-visual signal at an audio-visual signal output terminal of the receiving device to a display terminal; and
(h) displaying the remote conference on the display terminal.

2. The conference multi-terminal collaboration method, as recited in claim 1, before the step (b), further comprising steps of:
encoding the captured content by a receiver encoding module of the receiving device;
generating a captured information; and
wirelessly transmitting the data information by the wireless transceiver module.

3. The conference multi-terminal collaboration method, as recited in claim 2, wherein the step (c) comprises steps of:
(c1) receiving the captured information by a communication module of a transmission device;
(c2) decoding the captured information received from the communication module by an encoding module of the transmission device to obtain the captured content corresponding to the captured information;
(c3) transmitting the captured content by an audio-visual signal transmission terminal of the transmission device to a network terminal; and
(c4) running a remote conference program by the network terminal, inputting the corresponding remote conference based on the remote conference program, and inputting the captured content from the transmission device, and using the captured content as a real-time capture image uploading to a remote conference software.

4. The conference multi-terminal collaboration method, as recited in claim 3, wherein the step (d) comprises steps of:
(d1) inputting the audio-visual signal of the network terminal by an audio-visual signal transmission terminal of the transmission device from the network terminal;
(d2) encoding and processing the audio-visual signal inputted through the audio-visual signal transmission terminal by an encoding module to generate the data information; and
(d3) transmitting the data information by the communication module in a wireless manner.

5. The conference multi-terminal collaboration method, as recited in claim 2, wherein the step (c) comprises steps of:
(c1) receiving the captured information by a mobile terminal from the receiving device based on the mobile terminal's own projection protocol;
(c2) decoding and processing the captured information by the mobile terminal to obtain the captured content corresponding to the captured information; and
(c3) operating a remote conference program in the mobile terminal, inputting the corresponding remote conference based on the remote conference program, and using the captured content as a real-time capture image uploading to a remote conference software.

6. The conference multi-terminal collaboration method, as recited in claim 5, wherein the step (d) comprises steps of:
(d1) inputting the audio-visual signal of the network terminal by an audio-visual signal transmission terminal of the transmission device from the network terminal;
(d2) encoding and processing the audio-visual signal inputted through the audio-visual signal transmission terminal by the encoding module to generate the data information; and
(d3) transmitting the data information by the communication module in a wireless manner;
wherein the step (f) further comprises a step of:
(f1) decoding the data information by a decoding module of the receiving device to obtain the audio-visual signal corresponding to the data information.

7. The conference multi-terminal collaboration method, as recited in claim 1, further comprising steps of:
(i) inputting an audio-visual signal of a presentation terminal by an audio-visual signal transmission terminal of another transmission device from the presentation terminal, coding and processing the audio-visual signal inputted through the audio-visual signal transmission terminal by an encoding module of the another transmission device to generate a data information, and transmitting the data information by the communication module of the another transmission device in a wireless manner; and
(j) inputting the data information from the communication module of the another transmission device by the wireless transceiver module of the receiving device, decoding the data information received from the wireless transceiver module by the decoding module to obtain the audio-visual signal of the presentation terminal corresponding to the data information, transmitting the audio-visual signal of the network terminal and the audio-visual signal of the presentation terminal to the display terminal by the audio-visual transmission terminal, and displaying the corresponding remote conference and the presentation content on the display terminal at the same time.

8. The conference multi-terminal collaboration method, as recited in claim 7, wherein the step (i) further comprises steps of:
when a control module of the transmission device is operated once, beginning to encode the audio-visual signal by the encoding module, and
when the control module is operated again, switching back the encoding module to a dormant state and stopping encoding.

9. The conference multi-terminal collaboration method, as recited in claim 1, further comprising steps of:
(k) encoding and processing the corresponding audio-visual signal by a mobile terminal which is connected with the wireless transceiver module of the receiving device to generate the corresponding data information, and wirelessly transmitting the corresponding data information to the wireless transceiver module; and
(l) decoding the data information received by the wireless transceiver module by the decoding module of the receiving device to obtain the audio-visual signal of the mobile terminal corresponding to the data information, and transmitting the audio-visual signal of the presentation terminal and the audio-visual signal of the mobile terminal to the display terminal, displaying both the corresponding remote conference and the presentation content in the display terminal simultaneously.

10. The conference multi-terminal collaboration method, as recited in claim 9, wherein in the step (1), the receiving device transmits the audio-visual signal of the network terminal to the display terminal and transmits the audio-visual signal of the presentation terminal to another display terminal.

11. The conference multi-terminal collaboration method, as recited in claim 9, wherein in the step (1), the receiving device transmits the audio-visual signal of the network terminal to the display terminals and transmits at least one of the audio-visual signal of the presentation terminal and or the audio-visual signal of the mobile terminal to another display terminal.

12. A multi-terminal conference system for processing a remote conference by at least one network terminal, running a remote conference software, equipped with at least one camera and at least one display terminal, comprising:
at least one receiving device, comprising a wireless transceiver module, a decoding module, at least one audio-visual signal output terminal, and a camera input terminal, wherein the wireless transceiver module is connected to the decoding module, the audio-visual signal output terminal and the camera input terminal, wherein the camera input terminal is configured for connecting with the at least one camera to input the captured content from the at least one camera and transmit the captured content wirelessly through the wireless transceiver module, so as to use the captured content as a real-time capture image for uploading to the remote conference software, wherein the wireless transceiver module receives a data information of the audio-visual signal corresponding to the remote conference, wherein the decoding module is arranged to decode the data information received by the wireless transceiver module to obtain the audio-visual signal corresponding to the data information, wherein the audio-visual signal output terminal is configured for connecting with the display terminal to transmit the audio-visual signal to the display terminal so as for displaying the remote conference on the display terminal.

13. The multi-terminal conference system, as recited in claim 12, further comprising:
a transmission device, wherein while the network terminal is configured to run the remote conference software and input the corresponding remote conference based on the remote conference software, the transmission device comprises an audio-visual signal transmission terminal, an encoding module and a communication module, wherein the audio-visual signal transmission terminal is configured for connecting with the network terminal, and the encoding module is connected to the audio-visual signal transmission terminal and the communication module, wherein the wireless transceiver module is wirelessly connected with the communication module, the communication module of the transmission device is configured to input the data information wirelessly transmitted by the wireless transceiver module, wherein the data information is inputted by the network terminal from the audio-visual signal transmission terminal while the captured content is used as the real-time capture image uploading to the remote conference software, wherein the transmission device inputs the audio-visual signal of the network terminal from the network terminal at the audio-visual signal transmission terminal, wherein the encoding module encodes and processes the audio and video signal inputted by the audio and video signal transmission terminal and generates the data information, wherein the communication module transmits the data information in a wireless mode and the wireless transceiver module receives the data information.

14. The multi-terminal conference system, as recited in claim 13, further comprising:
a mobile terminal, which is configured to run the remote conference software and input the remote conference based on the remote conference software, wherein the mobile terminal is wirelessly connected to the wireless transceiver module of the receiving device based on a screen projection protocol of the mobile terminal to receive the data information transmitted by the wireless transceiver module while the captured content is used as the real-time capture image uploading to the remote conference software, wherein the mobile terminal transmits the data information corresponding to its audio-visual signal to the receiving device based on the screen projection protocol of the mobile terminal.

15. The multi-terminal conference system, as recited in claim 13, wherein the receiving device further comprises a receiving terminal encoding module and the transmission device further comprises a transmitting terminal decoding module, wherein the receiving terminal encoding module is connected to the camera input terminal and the wireless transceiver module and configured to encode and process the captured content inputted from the camera input terminal to generate a captured information, wherein the wireless transceiver module wirelessly transmits the captured information, wherein the transmitting terminal decoding module is connected to the communication module and the audio-visual signal transmission terminal and configured to decode the captured information to obtain the captured content corresponding to the captured information, wherein the audio-visual signal transmission terminal transmits the captured content to the network terminal.

16. The multi-terminal conference system, as recited in claim 14, wherein the receiving device further comprises a receiving terminal encoding module and the transmission device further comprises a transmitting terminal decoding module, wherein the receiving terminal encoding module is connected to the camera input terminal and the wireless transceiver module and configured to encode and process the captured content inputted from the camera input terminal to generate a captured information, wherein the wireless transceiver module wirelessly transmits the captured information, wherein the transmitting terminal decoding module is connected to the communication module and the audio-visual signal transmission terminal and configured to decode the captured information to obtain the captured content corresponding to the captured information, wherein the audio-visual signal transmission terminal transmits the captured content to the network terminal.

17. The multi-terminal conference system, as recited in claim 14, wherein the receiving device further comprises a receiver encoding module, wherein the receiver encoding module is connected to the camera input terminal and the wireless transceiver module, and configured to encode and process the captured content inputted from the camera input terminal to generate the captured information, wherein the wireless transceiver module wirelessly transmits the captured information, wherein the mobile terminal receives the captured information and decodes the captured information to obtain the captured content corresponding to the captured information.

18. The multi-terminal conference system, as recited in claim 13, wherein the transmission device further comprises an audio recorder module, which is connected to the audio-visual signal transmission terminal and is used to record a sound of a scene where the multi-terminal conference system is located, wherein the audio-visual signal transmission terminal transmits an audio content of the sound corresponding to the sound recorded by the audio recorder module to the network terminal, wherein the network terminal uses the audio content as a real-time audio uploading to the remote conference software.

19. The multi-terminal conference system, as recited in claim 13, further comprising at least one presentation terminal and at least one other transmission device, wherein an audio-visual transmission terminal of the other transmission device is configured to connect with the presentation terminal to input the audio-visual signal for the presentation terminal from the presentation terminal, wherein the encoding module of the other transmission device is configured to be able to encode and process the audio-visual signal inputted through the audio-visual signal transmission terminal to generate the data information, wherein the communication module of the another transmitting device is wirelessly connected to the wireless transceiver module of the receiving device and is arranged to transmit the data information in a wireless manner, wherein the wireless transceiver module receives the data information, and the decoding module is arranged to decode the data information received by the wireless transceiver module to obtain the audio-visual signal of the presentation terminal corresponding to the data information, wherein the audio-visual signal output terminal transmits the audio-visual signal of the network terminal and the audio-visual signal of the presentation terminal to the display terminal, thereby the display terminal displays both the corresponding remote conference and the presentation content at the same time.

20. The multi-terminal conference system, as recited in claim 13, wherein the transmission device comprises a control module, which is connected to the encoding module and used to control the encoding module to encode the audio-visual signal, wherein the encoding module is in a dormant state by default and is arranged in such a manner that, when the control module is operated once, the encoding module begins to encode the audio-visual signal, and when the control module is operated again, the encoding module switches back to the dormant state and stops encoding, thereby the audio-visual signal of the network terminal and the audio-visual signal of the presentation terminal are selectively transmitted to the display terminal.

21. The multi-terminal conference system, as recited in claim 18, further comprising at least one mobile terminal, which is wirelessly connected to the wireless transceiver module of the receiving device and configured to encode and process the audio-visual signal thereof to generate the data information, and to wirelessly transmit to the wireless transceiver module, wherein the decoding module is arranged to decode the data information received by the wireless transceiver module to obtain the audio-visual signal of the at least one mobile terminal corresponding to the data information, wherein the audio-visual signal output terminal is adapted to transmit the audio-visual signal of the at least one mobile terminal to the display terminal, thereby the display terminal displays the presentation content corresponding to the at least one mobile terminal, wherein by operating the control module of the other transmission device, the audio-visual signal of the presentation terminal and/or the audio-visual signal of the mobile terminal is able to be selectively displayed to the display terminal.

22. The multi-terminal conference system, as recited in claim 18, further comprising at least one mobile terminal, which is wirelessly connected to the wireless transceiver module of the receiving device and configured to encode and process corresponding audio-visual signals thereof to generate the data information, and to wirelessly transmit to the wireless transceiver module, wherein the decoding module is arranged to decode the data information received by the wireless transceiver module to obtain the audio-visual signal of the at least one mobile terminal corresponding to the data information, wherein the audio-visual signal output terminal transmits the audio-visual signal of the network terminal and the audio-visual signal of the mobile terminal to the display terminal, thereby the display terminal displays the remote conference and presentation content simultaneously.

23. The multi-terminal conference system, as recited in claim 21, wherein the receiving device further comprises another audio-visual signal output terminal connected with another display terminal, wherein the receiving device transmits the audio-visual signal of the network terminal to the display terminal and transmits the audio-visual signal of the presentation terminal and/or the audio-visual signal of the mobile terminal to the another display terminal.

24. The multi-terminal conference system, as recited in claim 21, wherein the receiving device further comprises another audio-visual signal output terminal connected with another display terminal, wherein the receiving device transmits the audio-visual signal of the network terminal to the display terminal and transmits the audio-visual signal of the mobile terminal to the other display terminal.

25. The multi-terminal conference system, as recited in claim 22, wherein the receiving device further comprises another audio-visual signal output terminal connected with another display terminal, wherein the receiving device transmits the audio-visual signal of the network terminal to the display terminal and transmits the audio-visual signal of the presentation terminal and/or the audio-visual signal of the mobile terminal to the another display terminal.

26. The multi-terminal conference system, as recited in claim 22, wherein the receiving device further comprises another audio-visual signal output terminal connected with another display terminal, wherein the receiving device transmits the audio-visual signal of the network terminal to the display terminal and transmits the audio-visual signal of the mobile terminal to the other display terminal.
